(19) United States
(12) Patent Application Publication
(10) Pub. No.: US 2010/0012910 A1
(43) Pub. Date: Jan. 21, 2010

(54) Barrier Improvements

(76) Inventor: Donald Stewart Napier, Victoria (AU)

Correspondence Address: THE NATH LAW GROUP, 112 South West Street, Alexandria, VA, 22314, US

(21) Appl. No.: 12/226,726

(22) PCT Filed: Apr. 23, 2007
(86) PCT No.: PCT/AU2007/000524

§ 371 Date: Oct. 27, 2008

(30) Foreign Application Priority Data
Apr. 28, 2006 (AU) 2006902199

(51) Int. Cl. E04H 17/02; E04H 17/14; B23P 11/00

(52) U.S. Cl. 256/34; 29/428

(57) ABSTRACT

A barrier provided by a plurality of wires, spaced apart one from the other and crossing between spaced apart elongate members, at least one of the wires having a bulbous end, and a first of the elongate members having an aperture either in or attached thereto, through which, in one position, the bulbous end of the wire is adapted to pass through, and in a second barrier providing position, is intercepted against withdrawal there from.

### FIELD OF THE INVENTION

This invention relates to barrier improvements including a barrier, an assembly including a barrier, and a method of constructing a barrier.

It is currently known to use a plurality of wires held under tension between end members and where the wires are spaced apart and are parallel one with respect to the other.

The term “wire” is intended, unless the context restricts such broader interpretation, both single strand and multi strand wires and will also include coated and uncoated wires where for instance a coated wire may include an outer surrounding plastics material.

It has been known to use multi strand wire especially between respective anchor points but there are difficulties with the current methods and resulting product.

We are in this case directing the discussion to a wire tightening system which may include a threaded shaft to which at one end there is swaged a wire, and at the other end of wire there is a ferrule.

The threaded shaft would normally be arranged to pass through an aperture within a cross piece such as a lower railing and the means to tighten the shaft and therefore the wire held by it would be by an appropriate threaded engaging member such as a nut.

The result of such an arrangement is that any tension applied then is directly in line with the wire which is then conventionally anchored at a further end to another anchor point.

The further end will normally be finished off by forming a loop and then swaging the free end to a further body of the wire.

A bracket then might be attached to an upper railing or to a side railing and typically this might be in the form of a U shaped bracket where each leg is able to be attached directly to the surface of the railing or side post for instance by rivets or by screws or even bolts.

The resulting product is therefore effective in an engineering sense but it has a number of problems both from an aesthetic, practical and economic sense.

The first of the problems is that looping off each wire is a time consuming task and together with this, the attachment at each of spaced apart positions of some anchor bracket such as a U shaped bracket or a D link of some sort incurs further costs and a laborious manipulation at each location.

Further, multi strand and even single strand wire once cut has an end or ends which can be ragged, or even if not ragged, can uncoil and effect quite a sharp cut if a person rubs against them. Furthermore, it is difficult to swage each wire to the same length.

This is especially the case if a person is wearing vulnerable clothing. There is further difficulty where animals might be involved where these might rub against the ends and could quite easily harm themselves.

From a visual point of view, in practice, the tightening mechanism implicitly needs a sufficient length for there to be a captured distance for the swaging, a threaded shaft at one end and then at the other, the formed loop, the bracket and this then standing apart from any surface to which it is attached.

A separate tensioning system could in another instance include for each wire length, a turnbuckle, but this requires finishing off of ends of wires, and as well does not provide a good visual impact as well incurs costs of extra fittings.

### BRIEF DESCRIPTION OF THE INVENTION

In one form of the invention this can be said to reside in a barrier provided by a plurality of wires, spaced apart one from the other and crossing between spaced apart elongate members, at least one of the wires having a bulbous end, and a first of the elongate members having an aperture either in or attached thereto, through which, in one position, the bulbous end of the wire is adapted to pass through, and in a second barrier providing position is intercepted against withdrawal there from.

Another aspect of this invention is that the first elongate member can be a hollow tube, and the aperture can be through a wall of the tube.

Another aspect of this invention is that the aperture can be of key hole shape.

Another aspect of this invention is that the bulbous end can be formed by a ferrule swaged around the wire.

Another aspect of this invention is that the bulbous end can be of generally circular shape in cross section and the aperture has a portion that has a shape and size where the circular shape of the bulbous end can pass therethrough and the aperture has a further portion which is of lesser size which allows for the wire to pass therethrough but which will intercept the bulbous end.

Another aspect of this invention is that the wire can be multistrand wire and is held to the second of the said members by means effecting a tensioning of the wire.

Another aspect of the invention is that there can be two spaced apart elongate members at least one of which is a railing, and a plurality of wires each extending between the said members and being spaced apart one from the other in parallel alignment to define a barrier thereby, and where at least one of the wires is attached to a one of the members at a one end to a tension adjustment means which is aligned to effect a tension in the wire in the wire direction of elongation, and at a further end to the further member where the end of the wire is of a shape where at least one diametral size is larger than an immediately preceding portion of the wire, and there is an aperture in or attached to the railing through which in one alignment, at least, the bulbous end is able to pass through, and in a further alignment with respect to the aperture, is being intercepted and held thereby from withdrawal.

Another aspect of this invention is that either a or the tension means can include a threaded shaft secured to a lower end of the wire, the shaft passing through an aperture within the second member, and a nut engaging the threaded shaft behind the aperture to effect tensioning of the wire thereby.

Another aspect of this invention is that the barrier as characterized can form a portion of a gate the respective members being sides of a surrounding frame for a gate.

Another aspect of this invention is as a fence in which there can be an upper railing, and a lower railing and there is at least one wire with a bulbous end extending between the upper railing and the lower railing, the upper railing being a hollow tube having a plurality of spaced apart apertures within a lower portion of the wall of the tube.

Another aspect of this invention is a method of assembly of a barrier where the barrier can be characterised by locating a respective bulbous end of a wire within an interlocking shape of a member and then effecting a realignment of such a bulbous end so as to be positioned from an insertable position to an interlocking position with respect to the aperture and effecting application of tension aligned with respect to the elongation direction of the wire to both effect a tension in the wire and also hold the wire in the interlocking position.

Another aspect of this invention is that there is provided that an end of a wire be made bulbous for instance by swaging a ferrule on the single thickness of the wire at an end of the wire (this term is considered to also include at an effective end which may mean some slight set back from the actual end as a convenience, in other words at least dose to an end of the wire), and then having an interlocking shape in an upper railing or its like where in one position, the bulbous end of the wire can pass through such an interlocking shape and then by further change in alignment the bulbous end will then be caused to intersect with the interlocking shape and be held thereby.

The advantage of such an arrangement is that an interlocking shape can be effected within a body of a railing so that from an external view, there is no complexity of pieces, or folded wires or even swaged ends.

In a further aspect of the invention, there is provided an upper railing which has an underneath aperture of keyhole shape where a swaged end of a wire has a diameter less than a larger diameter portion of the keyhole shape, and a remainder of the keyhole shape will allow the body of the wire to pass therein but will not allow the more bulbous portion of the bulbous end to pass therethrough.

In other words, by changing the alignment along the length of a keyhole shape, the bulbous end is able to be caught within the shape and thereafter by holding and maintaining tension, be kept in that position which is an interlocking position.

An advantage of this is that from a visual point of view, there now can be provided very clean lines indeed with literally nothing showing to a casual observer at least as far as the upper interconnecting system is concerned and it is also readily economic to put into practice because it is a much easier proposition to simply swage a single end of a wire and have a keyhole shape cut by appropriate means, e.g. laser cutting along a lowermost edge into a hollow shape.

A further advantage is that this arrangement can be adapted for use as a staircase railing, without the need to change the keyhole position or use wires of differing lengths.

This then does not envisage changing a tension system which is aligned with the elongation direction of the wire but is intended to provide a solution simply for the upper end.

While reference has been made to “an upper end” is not envisaged in a broader sense, that the technique be necessarily limited to a situation where it is only an upper end that will necessarily achieve this system.

It is also possible to use this system where wires extend laterally and in which the tension means are at one end and the interlocking system as described is at the other where for instance the other end is a post having within its hollow body keyhole shapes providing the function as described.

Generally speaking however, retaining the wires so that they extend vertically is considered to be the superior arrangement for these, as they cannot be climbed by a child.

Another aspect of this invention is then a barrier where there is a railing, and a plurality of wires each extending across and being spaced apart one from the so other in parallel alignment to define a barrier thereby, and where at least one of the wires is attached at a one end to a tension adjustment means which is aligned with the wire direction, and at the further end to the railing where the end of the wire is bulbous and there is an aperture in or attached to the railing into which in one alignment the bulbous end is adapted to pass through, and in a further alignment to be intercepted and be held thereby from withdrawal.

In preference, the aperture is of keyhole shape with a larger and smaller interconnected aperture and the alignment of the bulbous end is in one position, aligned with a larger portion of a keyhole shape, and being aligned with a smaller portion of the keyhole shape when intended to be intercepted and to be held thereby.

In preference, the tension means include a threaded shaft secured to a lower end of the wire and passing through an aperture within a support member, and a nut engaging the threaded shaft behind the aperture to effect the tension on the wire thereby.

In a further form, the invention can be said to reside in an assembly where the barrier is integrated into a gate so that end anchors are sides of a frame providing a surrounding frame for a gate.

In a further form, the invention could be said to reside in a method of assembly of a barrier which includes a barrier as described according to any of the previously described features where the method of assembly includes locating a respective bulbous end of a wire within an interlocking shape of a member and then effecting a realignment of such a bulbous end so as to be positioned from a releasable position to an interlocking position within the aperture and effecting application of tension aligned with respect to the elongation direction of the wire to both effect a tension in the wire and also hold the wire in the interlocking position.

### DESCRIPTION OF THE DRAWINGS

For a better understanding of this invention it will be described with reference to drawings wherein

FIG. 1 is a cross sectional view of a first embodiment showing a barrier acting as a fence,

FIG. 2 is a perspective view of the same first embodiment,

FIG. 3 is a perspective view with part cutaway of a second embodiment which is an arrangement that is appropriate for a gate,

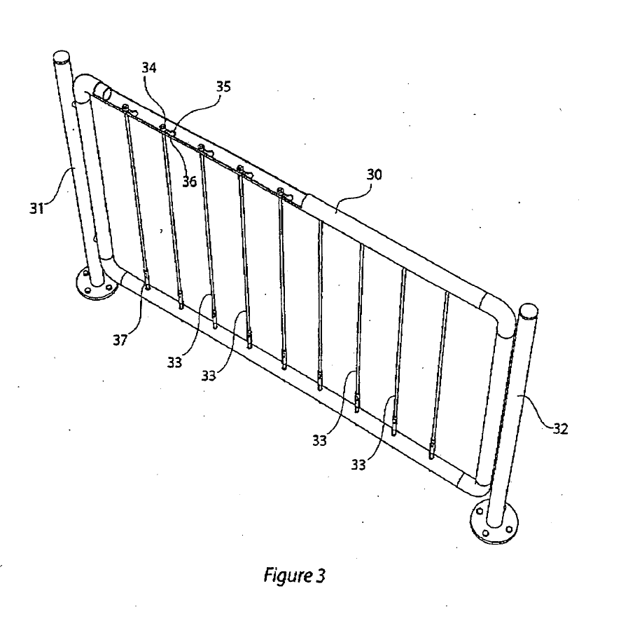

FIG. 4 is a perspective view with some dotted outline, and

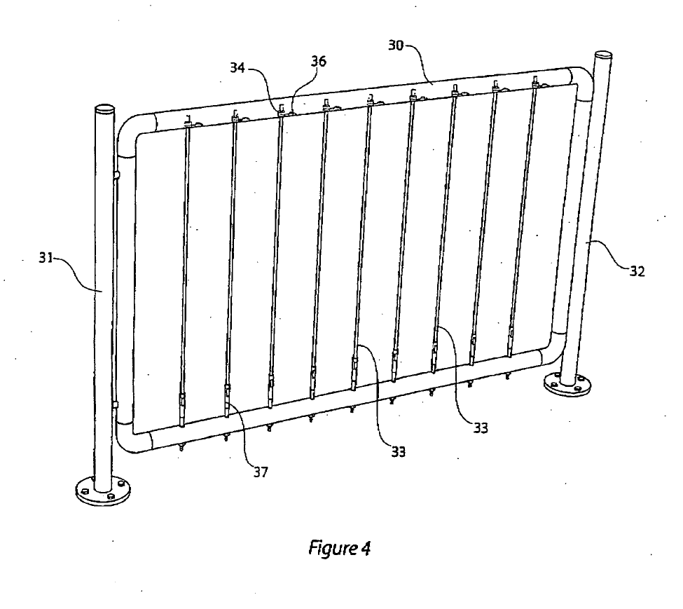

FIG. 5 is a perspective view in enlarged detail of the tensioning system used in both embodiments.

### DESCRIPTION OF THE EMBODIMENTS

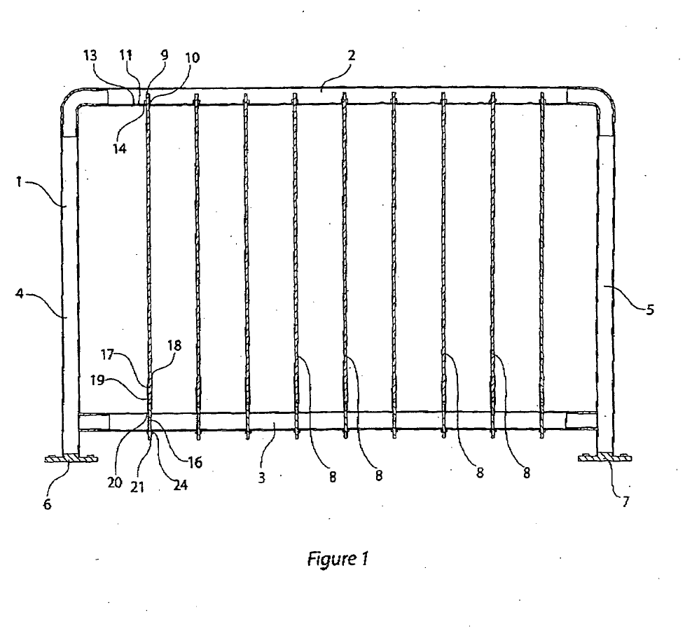

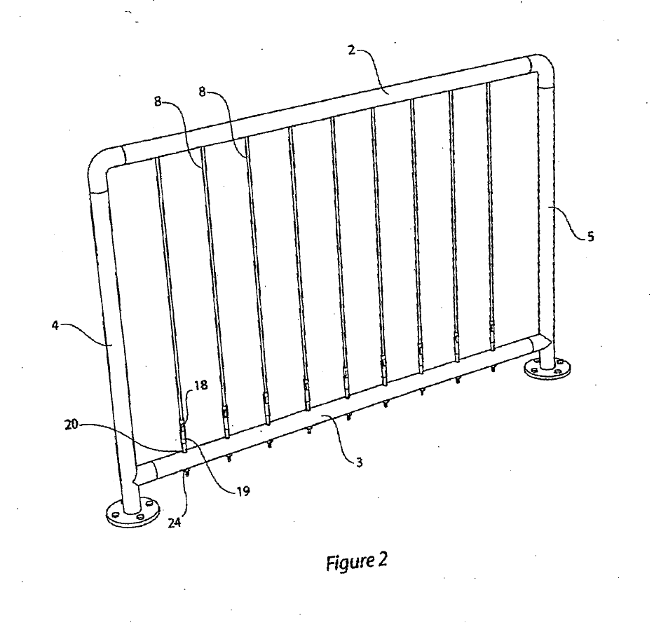

Referring in detail the embodiments and in particular to the first embodiment as shown in FIGS. 1 and 2, there is firstly shown a surrounding frame 1 which includes and provides an upper railing 2 and a lower railing 3 which is parallel to the first said railing 2.

These references to upper and lower are relative.

There are two vertical posts 4 on one side and 5 on the other which are anchored to the ground as at 6 in one case and 7 in the other.

There are a plurality of wires 8 each of which is spaced one from the other and in each case they are both parallel with respect to the other and spaced at equal distance apart from one another.

In order to provide an adequate barrier effect however, they are each to be tightened or tensioned and in the first instance and in accord with this embodiment, each uppermost end as shown at 9 has a ferrule swaged around an end or close to the end so as to be tightly anchored thereto.

The technique of swaging in this manner is well established and it is intended that conventional techniques for swaging in this instance can be used and if appropriate, non corrosive materials can be used according to conventional techniques.

However, the so called swaged end therefore has therefore been made bulbous and there is a keyhole slot 11 which is cut into the wall 12 of the upper member railing 2.

The keyhole aperture or slot 11 includes a portion of larger diameter at 13 the shape and size of which is such that the bulbous end and specifically the ferrule engaging around the wire will pass therethrough when appropriately aligned therewith, and thereafter, there is a narrower portion 14 of the keyhole slot 11 where the bulbous end provided by the ferrule 10 will now no longer pass freely through the keyhole slot portion and is therefore interlocking with the respective surface or wall of the railing 2. The slot 11 thus provides access to a cavity behind the slot which in this case is

The other end of the wire in this case is attached to a threaded shaft 16 by a tube 17 which is swaged both to capture the end 18 of the wire 8 and at the other end the upper end of the threaded shaft 16 at 19.

The threaded shaft is adapted to pass through appropriate apertures 20 and 21 in the tube providing the lower railing 3 and there is a nut 24 arranged to provide tensioning effect by appropriately screwing up the shaft.

As will now be seen, the tensioning arrangement is aligned with the body or direction of alignment of the wire 8 but of specific interest in accordance with this invention is the anchoring system at the other end which now provides a very efficient, economically effective and visually exciting holding technique.

Now referring to the second embodiment, this now simply shows a surrounding frame 30 of hollow tube which is formed in appropriate manner and such a frame then can be used to provide a barrier for any appropriate application for instance as a gate, or as an independent module for appropriate location between vertical posts as is shown in this case where the posts are shown at 31, 32.

In this case again then each of the wires 33 are multi strand stainless steel and have an upper end swaged and there is a keyhole slot such as at 35 which has a larger end 36 through which the swaged end 34 will pass, and by having the alignment of the respective tensioning system shown at 37 such that the larger portion of the keyhole 36 is slightly offset so that the narrower portion of the keyhole slot is actually closer to the tension assembly 37, then by applying tension, the position of the bulbous end 34 will be tending to be kept in the narrower end and therefore in the interlocking position.

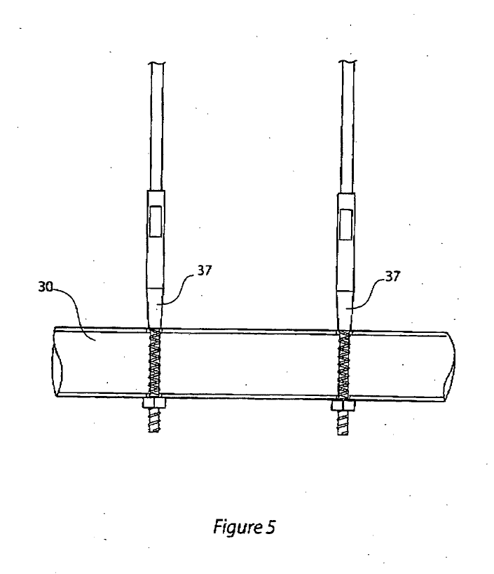

The tension arrangement is the same as in the first embodiment and there is a further enlarged detail of this in FIG. 5.

While the aligned tensioning system described is one possible approach it is not intended that, in its broadest form, that this might be the only form of tensioning and a conventional turnbuckle arrangement can also be used although this is relatively expensive and incurs some of the difficulties previously discussed.

The aligned tensioning device shown could be described as a swaged terminal threaded unit and this has some advantages in terms of economics over a turn buckle.

The advantage in both cases of the embodiments is that the wires do not have to be anchored where raw ends will be visible or even more easily to be accessible for animals or humans and apart from this, the visual appearance is to be significantly preferred.

Although the invention has been herein shown and described in what is conceived to be the most practical and preferred embodiment, it is recognised that departures can be made within the scope of the invention, which is not to be limited to the details described herein but is to be accorded the full scope of the appended claims so as to embrace any and all equivalent devices and apparatus.

1. A barrier provided by a plurality of wires, spaced apart one from the other and crossing between spaced apart elongate members, at least one of the wires having a bulbous end, and a first of the elongate members having an aperture either in or attached thereto, through which, in one position, the bulbous end of the wire is adapted to pass through, and in a second barrier providing position, is intercepted against withdrawal there from.

2. A barrier as in claim 1 further characterised in that the first elongate member is a hollow tube, and the aperture is through a wall of the tube.

3. A barrier as in claim 2 further characterized in that the aperture is of key hole shape.

4. A barrier as in claim 1 further characterized in that the bulbous end is formed by a ferrule swaged around the wire.

5. A barrier as in claim 1 further characterised in that the bulbous end is of generally circular shape in cross section and the aperture has a portion that has a shape and size where the circular shape of the bulbous end can pass therethrough and the aperture has a further portion which is of lesser size which allows for the wire to pass therethrough but which will intercept the bulbous end.

6. A barrier as in claim 1 further characterized in that the wire is a multistrand wire and is held to the second of the said members by means effecting a tensioning of the wire.

7. A barrier where there are two spaced apart elongate members at least one of which is a railing, and a plurality of wires each extending between the said members and being spaced apart one from the other in parallel alignment to define a barrier thereby, and where at least one of the wires is attached to a one of the members at a one end to a tension adjustment means which is aligned to effect a tension in the wire in the wire direction of elongation, and at a further end to the further member where the end of the wire is of a shape where at least one diametral size is larger than an immediately preceding portion of the wire, and there is an aperture in or attached to the railing through which in one alignment, at least, the bulbous end is able to pass through, and in a further alignment with respect to the aperture, is being intercepted and held thereby from withdrawal.

8. A barrier as in claim 1 wherein either a or the tension means includes a threaded shaft secured to a lower end of the wire the shaft passing through an aperture within the second member, and a nut engaging the threaded shaft behind the aperture to effect tensioning of the wire thereby.

9. An assembly where the barrier as in claim 1 is a portion of a gate the respective members being sides of a surrounding frame for a gate.

10. A fence in which there is an upper railing and a lower railing and there is at least one wire with a bulbous end extending between the upper railing and the lower railing, the upper railing being a hollow tube having a plurality of spaced apart apertures within a lower portion of the wall of the tube.

11. A method of assembly of a barrier where the barrier is characterized as in claim 1 directed to a barrier, the method of assembly including locating a respective bulbous end of a wire within an interlocking shape of a member and then effecting a realignment of such a bulbous end so as to be positioned from an insertable position to an interlocking position with respect to the aperture and effecting application of tension aligned with respect to the elongation direction of the wire to both effect a tension in the wire and also hold the wire in the interlocking position.
